(19) United States
(12) Patent Application Publication
(10) Pub. No.: US 2018/0213196 A1
(43) Pub. Date: Jul. 26, 2018

(54) METHOD OF PROJECTION MAPPING

(71) Applicant: BRUVIS MULTI MEDIA CREATIVE CO., LTD., New Taipei City (TW)

(72) Inventor: Hsiang Lung CHENG, Taoyuan City (TW)

(73) Assignee: BRUVIS MULTI MEDIA CREATIVE CO., LTD., New Taipei City (TW)

(21) Appl. No.: 15/413,164

(22) Filed: Jan. 23, 2017

(51) Int. Cl. H04N 9/31; G06T 15/20; G06T 19/20

(52) U.S. Cl. CPC H04N 9/3185; G06T 15/205; G06T 19/20; G06T 2215/16; H04N 9/3194; G06T 2219/2016; H04N 9/3147

(57) ABSTRACT

A method of projection mapping includes a modeling step for forming a 3D model of an object on an electronic device; a converting step for converting a video into an attachment image; a projecting step for attaching the attachment image to the 3D model to form a projection model; an image capturing step for capturing an image of the projection model at an angle of view; a mapping step for mapping the captured image onto the object, and an adjusting step for rotating, shifting and resizing the projection model on the electronic device. Alternatively, the converting and projecting steps may be performed after the image capturing, mapping and adjusting steps but followed by a re-capturing step and a re-mapping step. If the object is deformed or its angle or position relative to a projection device is changed, the image can be immediately modified directly on the electronic device accordingly.

### FIELD OF THE INVENTION

The present invention relates to a method of projection mapping for projecting and mapping a video or a picture onto a three-dimensional target object, and more particularly, to a method of projection mapping that enables quick modification of the image to be projected directly on an electronic device when there are changes in the shape of the target object or in the relative position between the target object and a projection device.

### BACKGROUND OF THE INVENTION

Projection mapping is a projection technology, which uses a projection apparatus to project a video onto the surfaces of a physical object to present a fine artwork or an advertisement. By projecting a particularly designed video on the surfaces of a physical object, such as the walls of a building, a stage, an exhibition place or a relatively large product, for example an automobile, to create special changeful colors, patterns or other visual effects. Recently, projection mapping has become a widely welcome and popular live visual performance technology used in a verity of performing activities.

According to the currently known projection mapping technology, an angle of view of a projector relative to the physical object to be projected on, or the target object, is recorded firstly, and then a video is designed to be projected in a direction matching the recorded angle of view. Further, the position and the contour of the target object to be correspondingly presented in the designed video is calculated, and portions of the video other than the image of the target object are blacked out. Finally, the finalized video is projected from the corresponding projector onto the target object, making it looks like the video is played on the surfaces of the target object.

There are some limits to the current projection mapping technology. First, since the angle of view of the projector relative to the target object is first decided to enable the design of the video to be projected in the same direction of the angle of view, the recorded angle of view is fixed and not changeable. In the event the angle of view of the projector relative to the target object is changed, the entire video must be re-designed. Similarly, in the event there is any difference in the existing contour and position of the target object after the video is designed, the previously designed video must also be re-designed, which is of course troublesome. Second, each video is designed for projecting onto the target object in a direction matching the previously decided angle of view, so that a two-dimensional video can be correspondingly shown on the three-dimensional surfaces of the target object. In the event different videos are to be projected onto the same target object, it is also necessary to re-designed all the videos.

### SUMMARY OF THE INVENTION

A primary object of the present invention is to provide a method of projection mapping, according to which, when there is any change in an orientation, a position and/or an angle of a projection device relative to a target object onto which an image is to mapped, and even any change in a contour of the target object, a video to be projected on the target object can be directly modified on an electronic device in correspondence with such change to reduce the time and cost for re-designing the video for projection mapping.

Another object of the present invention is to provide a method of projection mapping, according to which, a plurality of videos for projection mapping onto a target object in different directions can be quickly produced and projected to reduce possible projection dead angles caused by the shape of the target object.

A further object of the present invention is to provide a method of projection mapping, according to which, a plurality of videos for projection mapping onto a target object at the same time in different directions can be quickly produced and mapped onto the entire surfaces of the target object.

To achieve the above and other objects, the method of projection mapping according to a first embodiment of the present invention for mapping an image onto a target object includes a modeling step, an image capturing step, a mapping step, an adjusting step, a converting step, a projecting step, a re-capturing step and a re-mapping step.

In the modeling step, a three-dimensional (3D) model is built on or imported into an electronic device, and the 3D model has a shape substantially the same as that of the target object. In the present invention, the building of the 3D model is not particularly limited to any specific way. The 3D model can be manually built by using the currently known 3D drawing software along with pictures of the target object, or by laser scanning, ultrasonic scanning and so on, or by using pictures taken with a drone in different directions.

In the image capturing step, an image containing the 3D model viewed at a specific angle of view is captured using the electronic device.

After the image is established, the mapping step and the adjusting step are performed. In the mapping step, a projection device is used to map the image onto the target object in a direction matching the angle of view. In practical implementing the present invention, there is not any particular limit to the number and the type of the projection device.

In the adjusting step, the 3D model can be rotated, shifted and/or re-sized directly on the electronic device until the contour of the 3D model in the image projected from the projection device fully matches the contour of the target object. According to the present invention, there is not any particular limit to the way for determining whether the contour of the 3D model has already matched the contour of the target object.

In the converting step, after the contour of the 3D model has matched the contour of the target object, a video built in the electronic device or imported from other data source is converted into an attachment image. In some embodiments, the video is a pattern for projection mapping. Then, in the projecting step, the attachment image is put onto the surface of the 3D model that has been well adjusted in the adjusting step, so that the attachment image and the 3D model together form a projection model. In the present invention, there is not any particular limit to the sequence of performing other steps other than the converting step and the projecting step.

Thereafter, the re-capturing step and the re-mapping step are performed. In the re-capturing step, a projection image containing the projection model is captured at the angle of view on the electronic device. Then, in the re-mapping step, the projection image is projected by the projection device at the angle of view to map onto the target object.

To achieve the above and other objects, the method of projection mapping according to a second embodiment of the present invention for mapping an image onto a target object includes a modeling step, a converting step, a projecting step, an image capturing step, a mapping step and an adjusting step.

Unlike the first embodiment, in the second embodiment, the modeling step, the converting step and the projecting step are sequentially performed before the image capturing step, the mapping step and the adjusting step; and the re-capturing step and the re-mapping step are omitted from the method according to the second embodiment. However, even with the change in the sequence of performing the steps of the method, the modeling step and the converting step in the second embodiment are the same as those in the first embodiment.

According to the second embodiment, in the projecting step, the attachment image is put onto the surface of the 3D model to together form a projection model; in the image capturing step, an image containing the projection model viewed at a specific angle of view is captured using the electronic device; and in the mapping step, a projection device is used to project and map the image containing the projection mode onto the target object in a direction matching the angle of view.

At last, in the adjusting step, the projection model that is seen on the electronic device is rotated, shifted and/or re-sized until the projection model contained in the image projected from the projection device has a contour completely matching the contour of the target object.

To achieve the above and other objects, the method of projection mapping according to a third embodiment of the present invention for mapping an image onto a target object is established on the basis of the first or the second embodiment and further includes a re-adjusting step, in which the projection model is adjusted again when an orientation, an angle and/or a position of the projection device relative to the target object is changed, such that the projection model contained in the image projected from the projection device matches the contour of the target object again. In the present invention, there is not any particular limit to the way for detecting and sensing the changes in the position, orientation and/or viewing angle of the projection device relative to the target object.

The method of projection mapping according to the third embodiment of the present invention further includes a re-modeling step, in which the contour of the 3D model is modified in correspondence with any difference between an original contour and an after-deformation contour of the target object, such that the modified contour of the 3D model is the same as the after-deformation contour of the target object; and then all other steps are performed again until the contour of the 3D model contained in the image fully matches the contour of the target object.

According to the present invention, in the image capturing step in the above described embodiments, a background removal process can be performed on the captured image, such that only the contour and the pattern of the projection model contained in the image capture at the angle of view are presented in the image, and some unnecessary portions on the image can be omitted as much as possible to thereby enhance the quality of the image projected from the projection device. In some other embodiments, the background removal process enables the electronic device to conveniently determine the contour of the projection model and the 3D model using some programs.

According to a fourth embodiment of the present invention established on the basis of the previous embodiments, the projection device includes a first projection unit and a second projection unit, and a first angle of view and a second angle of view are used in the image capturing step. The first projection unit projects a first image at the first angle of view to map the first image onto the target object and the second projection unit projects a second image at the second angle of view to map the second image onto the target object, such that a common mapping zone, onto where both the first and the second image are mapped, is created on the target object. With the common mapping zone, it is possible to reduce projection dead angles caused by a shape of the target object that includes raised and recessed areas.

According to a fifth embodiment of the present invention established on the basis of the previous embodiments, the projection device includes a first projection unit, a second projection unit and a third projection unit, and a first angle of view, a second angle of view and a third angle of view are used in the image capturing step. The first, second and third projection units are set surrounding the target object at three different angular positions relative to the target object for projecting a first, a second and a third projection image at the first, the second and the third angle of view, respectively, to map the first, the second and the third image onto the target object; and the first, the second and the third image together cover an entire outer surface around the target object to increase the areas on the target object that are mapped by the attachment image.

In summary, all the embodiments of the method of the present invention are established to enable quick re-design of the video for projection mapping when there is any change in the orientation, position and angle of the projection device relative to the target object. The first step in the method according to all the embodiments is the modeling step, in which a 3D model is built on the electronic device. Thereafter, the video to be present on the target object is converted into the attachment image for putting on the surface of the 3D model to form the projection model. Finally, the projection image containing the projection model is captured in the direction matching the angle of view for projection mapping onto the target object via the projection device. According to the conventional projecting mapping technique, the angle of view of the video is determined first, and other subsequent processes are performed accordingly. Unlike the conventional projection mapping technique, in the method of projection mapping according to the present invention, in the event there is any change in the orientation, position and angle of the projection device relative to the target object and the video for the projection mapping must be reset, the user needs only to adjust the video in correspondence with the relative changes between the target object and the projection device and to reset the angle of view for capturing the image containing the projection model directly on the electronic device.

Further, in the event the shape of the target object is changed, the user needs only to change the shape of the 3D model in the modeling step to correspond to the changed shape of the target object, and to perform the image capturing step and other subsequent steps again without the need of producing the video again in the starting step of selecting a new angle of view, which is otherwise necessary in the conventional projection mapping technique.

Finally, when it is desired to increase the areas on the target object that can present the attachment image to reduce possible projection dead angles, the user needs only to use a plurality of the projection units of the projection device and to capture in the image capturing step a plurality of images at a plurality of angles of view, and then projects the images onto the target object at the same time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in the method of projection mapping according to a first embodiment of the present invention;

FIG. 2 is a pictorial description of the modeling step and the image capturing step in the method of projection mapping of FIG. 1;

FIG. 3 is a pictorial description of the mapping step in the method of projection mapping of FIG. 1;

FIG. 4 is a pictorial description of the adjusting step in the method of projection mapping of FIG. 1;

FIG. 5 is a pictorial description of the converting step, the projecting step and the re-capturing step in the method of projection mapping of FIG. 1;

FIG. 6 is a pictorial description of the re-mapping step in the method of projection mapping of FIG. 1;

FIG. 7 is a flowchart showing the steps included in the method of projection mapping according to a second embodiment of the present invention;

FIG. 8 is a pictorial description of the modeling step in the method of projection mapping of FIG. 7;

FIG. 9 is a pictorial description of the converting step, the projecting step and the image capturing step in the method of projection mapping of FIG. 7;

FIG. 10 is a pictorial description of the mapping step in the method of projection mapping of FIG. 7;

FIG. 11 is a pictorial description of the adjusting step in the method of projection mapping of FIG. 7;

FIG. 12 is a flowchart showing the steps included in the method of projection mapping according to a third embodiment of the present invention;

FIG. 13 is a pictorial description of the re-modeling step in the method of projection mapping of FIG. 12, in which an original contour of the 3D model built in the modeling step is modified to match an after-deformation contour;

FIG. 14 shows the method of projection mapping according to a fourth embodiment of the present invention, in which two projection units are used in the mapping step to avoid forming any shadow on a target object; and

FIG. 15 shows the method of projection mapping according to a fifth embodiment of the present invention, in which multiple projection units are used in the mapping step to increase the areas on the target object that are mapped by a video.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

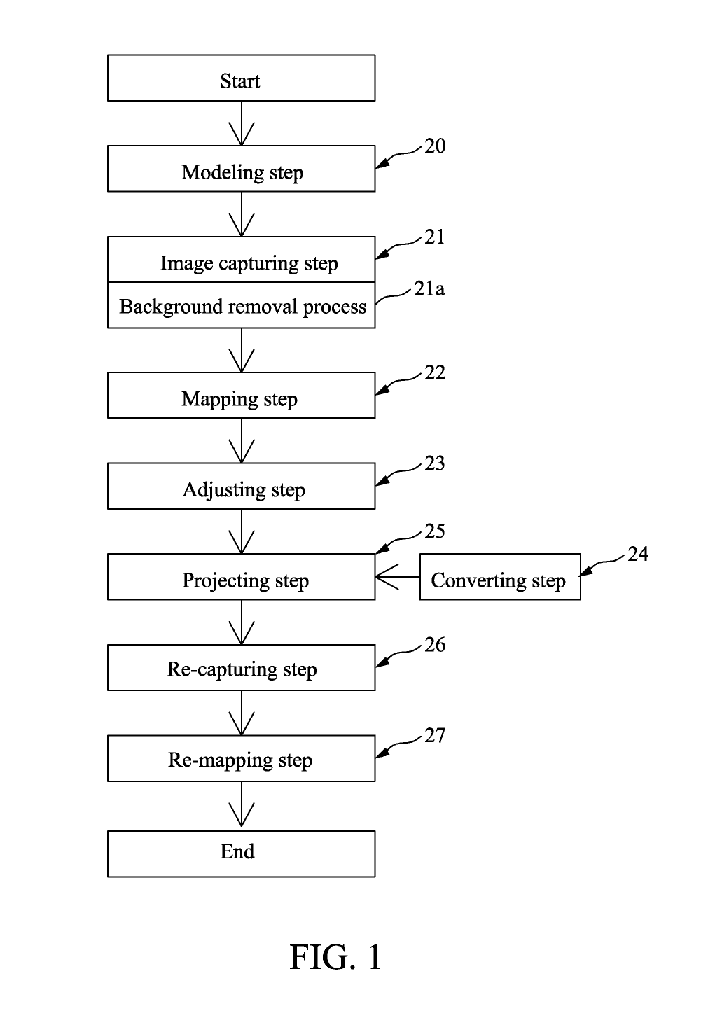

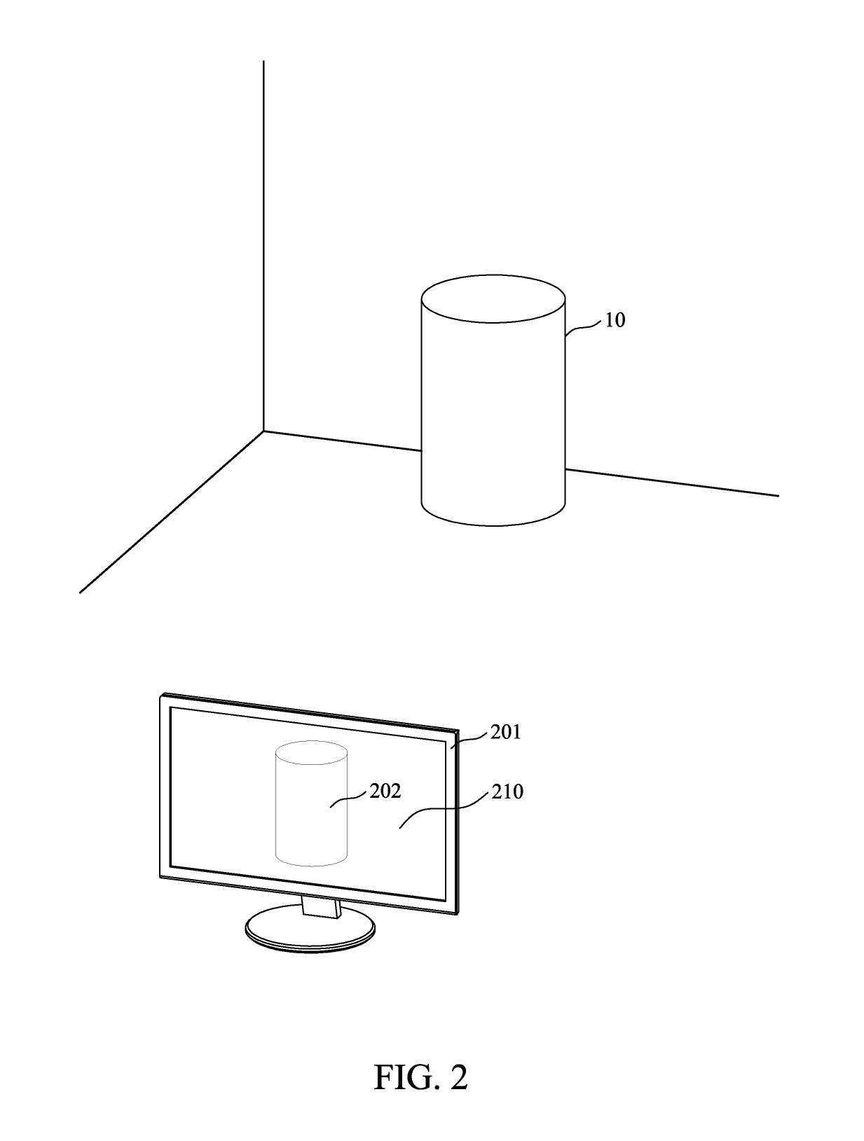

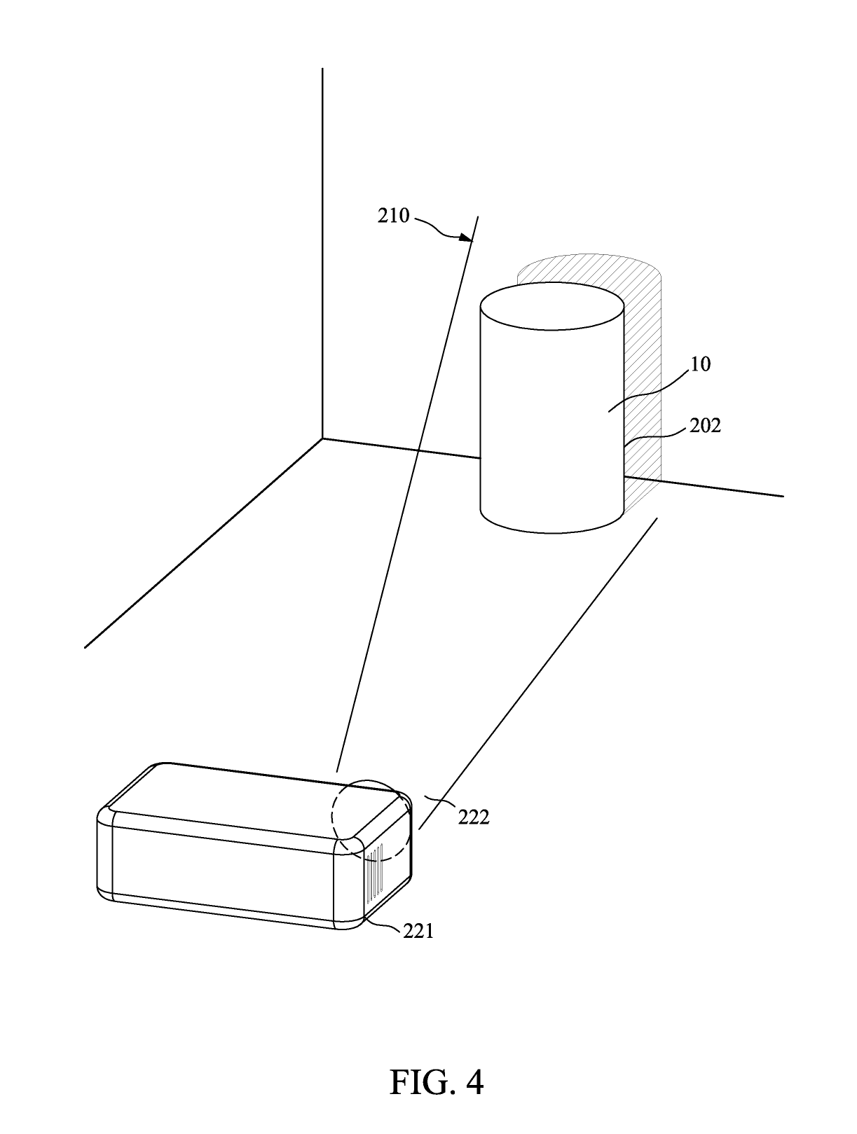

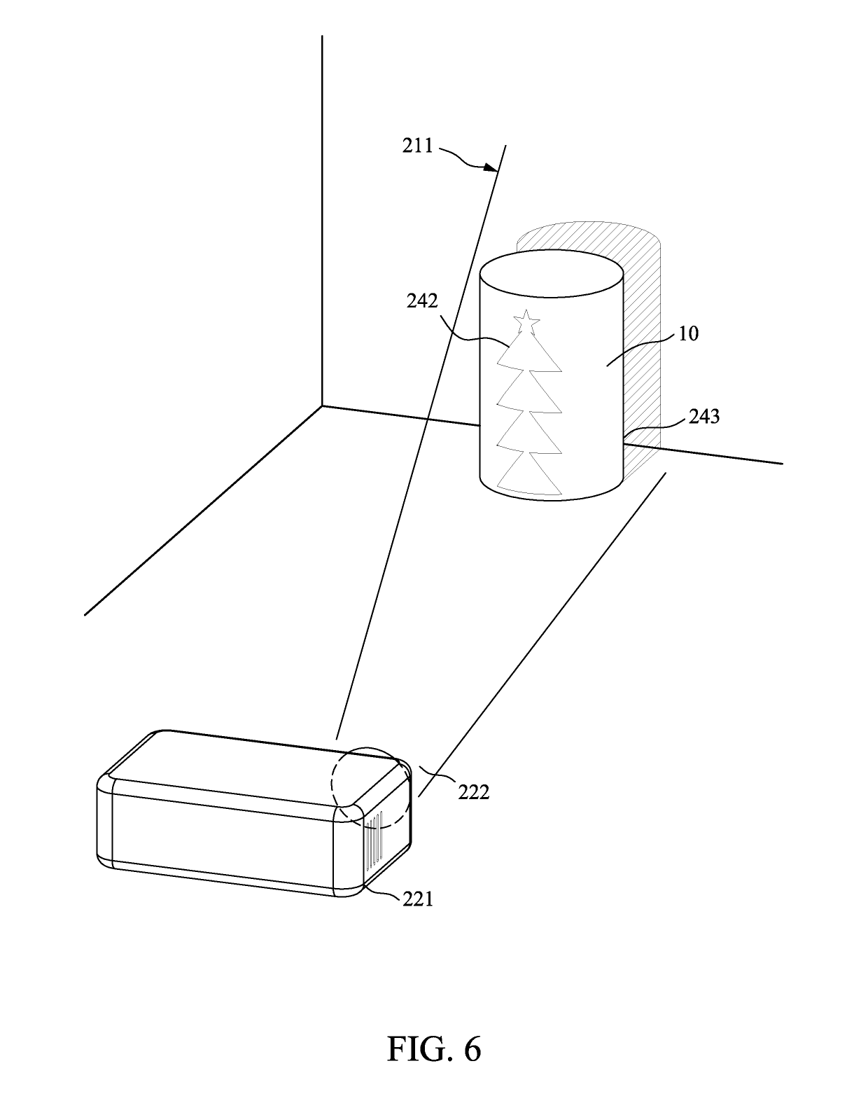

Please refer to FIGS. 1 to 6, wherein FIG. 1 is a flowchart showing the steps included in a method of projection mapping according to a first embodiment of the present invention. The method of projection mapping is used to project and map an image onto a target object 10. As shown in FIG. 1, the steps included in the first embodiment of the present invention includes a modeling step 20, an image capturing step 21, a mapping step 22, an adjusting step 23, a converting step 24, a projecting step 25, a re-capturing step 26, and a re-mapping step 27. FIGS. 2 to 6 are pictorial descriptions of these steps.

As shown in FIGS. 1 and 2, in the modeling step 20, a three-dimensional (3D) model 202 is built on an electronic device 201, such as a computer, using related programs. Alternatively, a previously built 3D model 201 can be imported from another computer into the electronic device 201 for use. The 3D model 202 should have a shape substantially the same as the target object 10. It is because the integrality of the 3D model 202 has a direct influence on the ability of a subsequently created image 210 to be used in different projection mapping conditions. The more the 3D model 202 resembles the target object 10, the more the subsequently created image 210 is adaptable to changes in the angle, position and direction of the target object 10 relative to a projection device 220 used to project and map images. It is to be noted the 3D model 202 is not necessarily a real three-dimensional model. In the case the target object 10 is a substantial flat object, such as a flag, the 3D model 202 can be a two-dimensional model. The use of the term “3D” only means the subsequent image capturing step 21 can be performed from three dimensions at different angles.

It is also to be noted that, in the present invention, the electronic device 201 is not particularly limited to any specific type. The electronic device 201 can include but not limited to a desktop computer, a notebook computer, a mobile phone and a tablet computer. Further, in the present invention, the building of the 3D model 202 is also not particularly limited to any specific way. In practical implementation of the present invention, the 3D model 202 can be built by using the currently known 3D drawing software along with pictures of the target object 10, or by laser scanning, ultrasonic scanning and so on, or by using pictures taken with an all-directional camera mounted on a drone. Any other way that is not mentioned herein but can be used to create the 3D model 202 of the target object 10 on the electronic device 201 should be included in the scope of the present invention.

After the 3D model 202 is built, the method goes to the image capturing step 21. In the image capturing step 21, an image 210 containing the 3D model 202 viewed at a specific angle of view 222 is captured using the electronic device 201, i.e. the computer. The captured image 210 can be reviewed and confirmed on a screen of the computer. The angle of view 222 can be freely selected according to actual need of use. In the illustrated first embodiment, the angle of view 222 is, but not limited to, an angular direction displayed on the screen of the electronic device 201. For the purpose of convenient representation, the angle of view 222 is not shown in FIG. 2.

In the image capturing step 21, the image 210 is further subjected to a background removal process 21a, so that only the contour of the 3D model 202 can be seen in the image 210 captured at the angle of view 222. In the present invention, there is not any particular limit to the way for the background removal process 21a. For example, the conventional way to show black contour on white background or any other technique for removing the background from an image to highlight an object all can be utilized to complete the background removal process 21a, so that the visible part in the image 210 is consistent with the 3D model 202. However, according to the present invention, the background removal process 21a is not necessarily performed in the image capturing step 21. In some other embodiments, the background removal process 21a can be performed in other steps of the method of the present invention or even be omitted. In some operable embodiments of the present invention, the computer can input an image captured by a camera unit associated with the projection device 220, so that a user can verify directly on the computer as how the projection device 220 is actually oriented to the target object 10 and to simulate the look in which the captured image 210 is projected and mapped onto the target object 10.

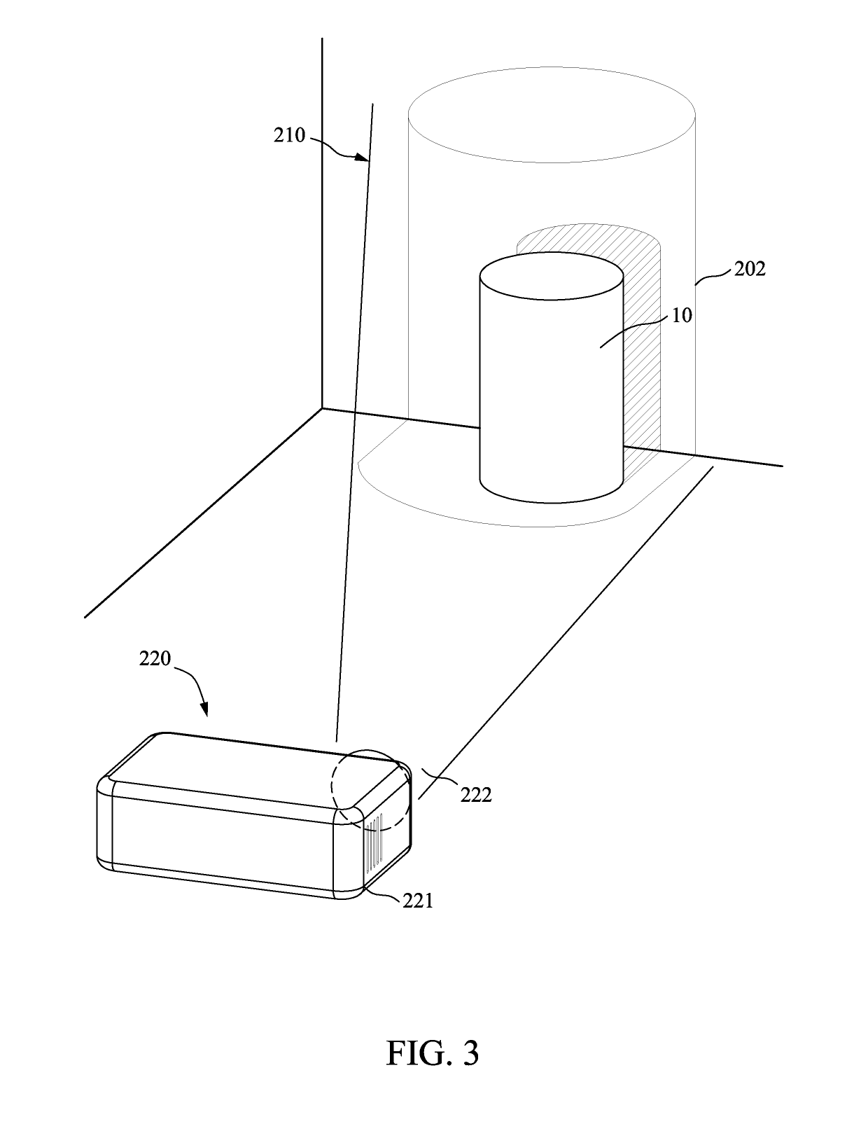

Please refer to FIGS. 1 and 3. After the image 210 is established, the method goes to the mapping step 22. In the mapping step 22, a projection unit 221 of the projection device 220 is used to project the image 210 onto the target object 10 in a direction matching the angle of view 222. In the present invention, there is not any particular limit to the number and the type of the projection unit 221. Any projector that can be used to project an image can be used for the present invention.

Then, please refer to FIGS. 1, 3 and 4. When the image 210 is projected by the projection unit 221 onto the target object 10, the contour of the 3D model 202 contained in the image 210 might be different from the actual contour of the target object 10 due to some factors, such as the projection device, the site or other factors. Therefore, the 3D model 202 contained in the image 210 still requires adjustments by rotating, shifting or re-sizing the 3D model 202. For this purpose, the method goes to the adjusting step 23.

In the adjusting step 23, the 3D model 202 can be rotated, shifted and/or re-sized directly on the computer until the contour of the 3D model 202 in the image 210 projected from the projection unit 221 fully matches the contour of the target object 10. Thereafter, other subsequent steps can be performed.

It is to be noted that, in the illustrated first embodiment, the adjusting step 23 is performed on the electronic device 201 to directly rotate, shift or re-size the 3D model 202 seen on the screen of the electronic device 201 to affect the 3D model 202 in the image 210 captured at the angle of view 222 and accordingly, the 3D model 202 that is projected from the projection unit 221. That is, the rotation, shifting and re-sizing for the purpose of adjusting the contour of the 3D model 202 are not performed on the 3D model 202 that is projected from the projection unit 221. Wherein, the adjustment can be the rotation, shifting and re-sizing done on the 3D model 202 in the image 210, or can simply be any change of the position of an observation point in the captured image 10.

Also, according to the present invention, there is not any particular limit to the way for determining whether the contour of the 3D model 202 has already matched the contour of the target object 10. In the illustrated first embodiment, it is the user who directly manually determines whether the contour of the 3D model 202 in the image 210 matches the target object 10. However, in some other embodiments, the user may use a relevant program built in the computer, such as an image analysis program, to work on the image 210 projected by the projection unit 221 and directly captured by the camera unit on the projection device 220, as well as the image of the target object 10 that is observed at the location of the projection unit 221, so that the computer can automatically and instantly determine whether the contours of the 3D model 202 and the target object 10 match each other or not, and then make necessary modifications.

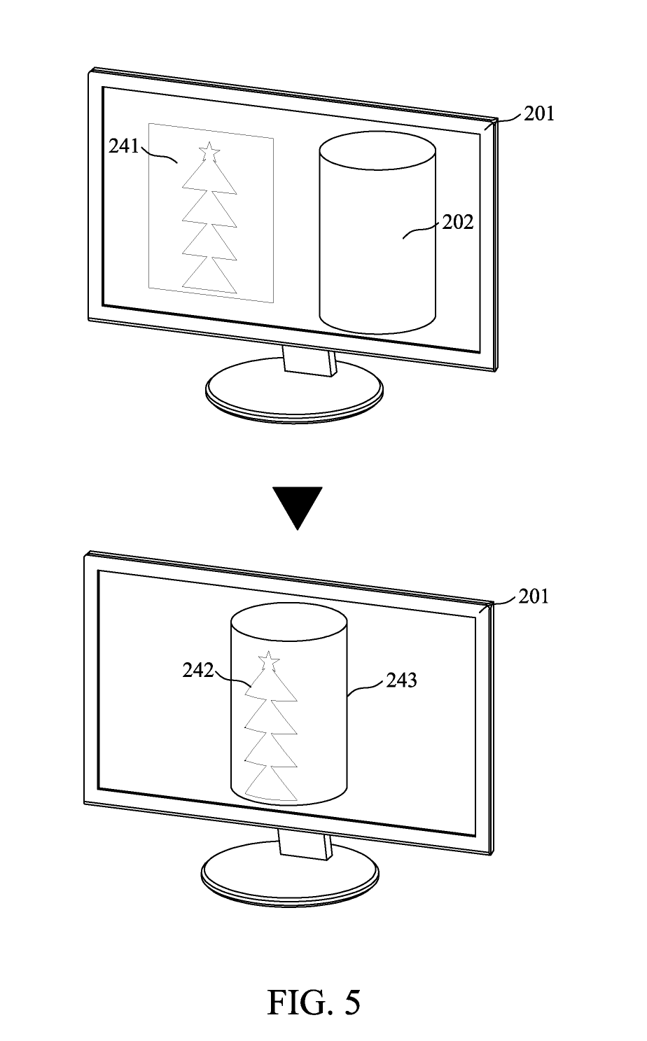

Please refer to FIGS. 1 and 5. In the converting step 24, a video 241 built in the electronic device 201 (i.e. the computer) or imported from other data source is converted into an attachment image 242 using the conventional technique of DirectX or OpenGL. Similarly, in the present invention, there is not any particular limit to the way for converting the video 241 into the attachment image 242. The techniques of DirectX and OpenGL mentioned herein are only illustrative and not intended to limit the present invention. Also, there is not any particular limit to the type or details of the video 241. In some operable embodiments, the video 241 can be a static picture. But in some other embodiments, the video 241 can be a dynamic video 241.

Please refer to FIGS. 1, 5 and 6. After the attachment image 242 is created, the method goes to the projecting step 25. In the projecting step 25, the attachment image 242 is put onto the surface of the 3D model 202 that has been well adjusted in the adjusting step 23, so that the attachment image 242 and the 3D model 202 together form a projection model 243. Then, the re-capturing step 26 and the re-mapping step 27 are performed.

In the re-capturing step 26, a projection image 211 containing the projection model 243 is captured at the angle of view 222 on the electronic device 201. Then, in the re-mapping step 27, the projection image 211 is projected by the projection unit 221 at the angle of view 222 to be mapped onto the target object 10, so that the 3D model 202 in the image 210 previously projected from the projection unit 221 is changed to the projection model 242. In this manner, the attachment image 242 is presented on the target object 10.

As can be seen from the above description, in the projection model 243 contained in the last image 210 projected by the projection unit 221, the shape of the presented attachment image 242 has already been adjusted in the adjusting step 23 to match the surface shape of the 3D model 202 in the projecting step 25. Therefore, when the user intends to change the video 241 to be projected by the projection device 220, the user can directly replace the attachment image 242 on the projection model 242 with another desired video and make necessary adjustments to complete the change without the need to build a new 3D model for showing the desired video 241.

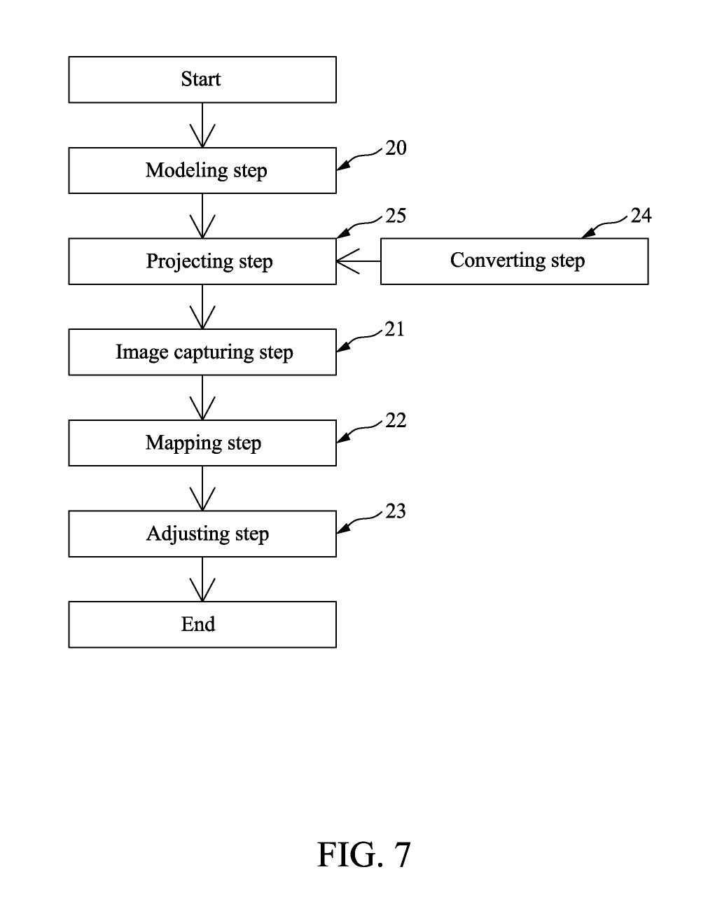

It is understood the above descriptions with reference to FIGS. 1 to 6 are directed to only one of many operable embodiments of the method according to the present invention. Please further refer to FIGS. 7 to 11, in which the method of projection mapping according to a second embodiment of the present invention is shown. The method of the present invention in the second embodiment is also used to project and map an image onto a target object 10, and sequentially includes a modeling step 20, a converting step 24, a projecting step 25, an image capturing step 21, a mapping step 22 and an adjusting step 23.

In the above-described first embodiment, the converting step 24 and the projecting step 25 are performed after the adjusting step 23 and the re-capturing step 26 and the re-mapping step 27 are performed after the projecting step 25. Unlike the first embodiment, in the method according to the second embodiment of the present invention, the converting step 24 and the projecting step 25 are performed immediately after the modeling step 20 and the re-capturing step 26 and the re-mapping step 27 are omitted. Since the modeling step 20 and the converting step 24 in the second embodiment is substantially the same as those in the first embodiment, they are not repeatedly described herein. The following descriptions will directly go to the projecting step 25.

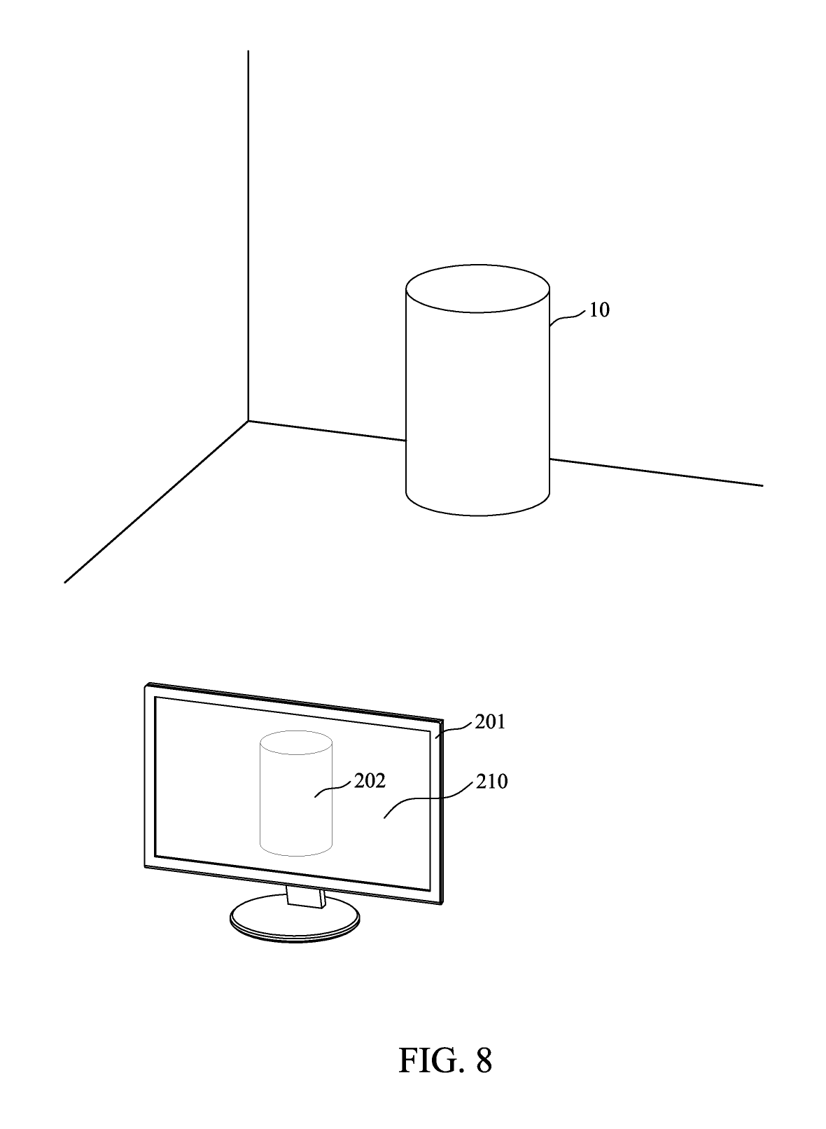

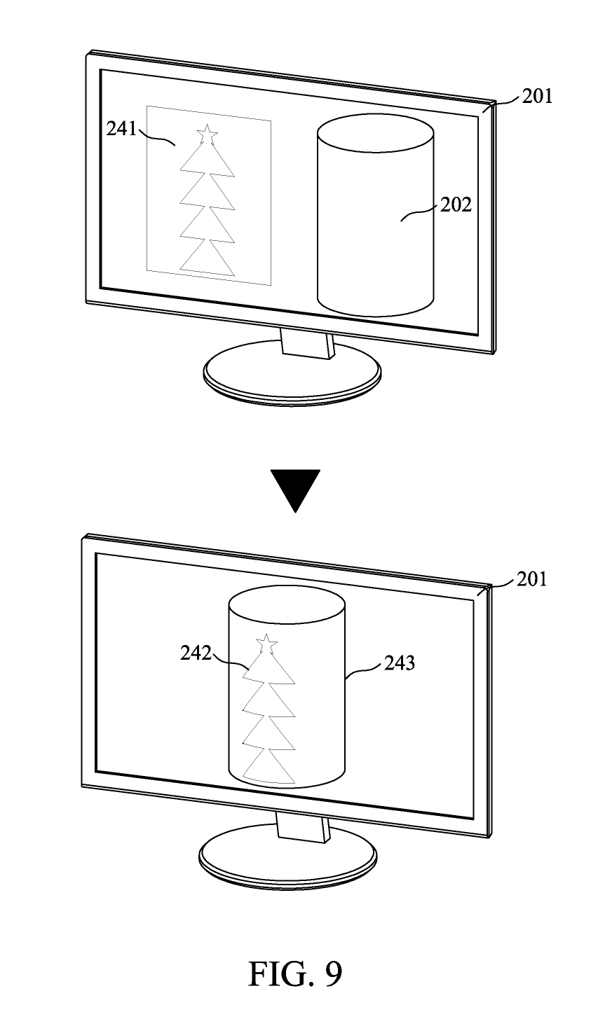

After the modeling step 20 shown in FIG. 8 and the converting step 24 shown in FIG. 9 have been performed, the method goes to the projecting step 25, a pictorial description of which is also shown in FIG. 9. In the projecting step 25, the attachment image 242 is put onto the surface of the 3D model 202 to together form a projection model 243. It is to be noted that, in the projecting step 25 according to the second embodiment, the 3D model 202 has not been subjected to an adjusting step 23 for any adjustment.

Then, the method goes to the image-capturing step 21. In the image capturing step 21, an image 210 containing the projection model 243 viewed at a specific angle of view 222 is captured using the electronic device 201, i.e. the computer. Similarly, in the second embodiment, the angle of view 222 is, but not limited to, an angular direction displayed on the screen of the electronic device 201. However, for the purpose of convenient representation, the angle of view 222 is not shown in FIG. 9.

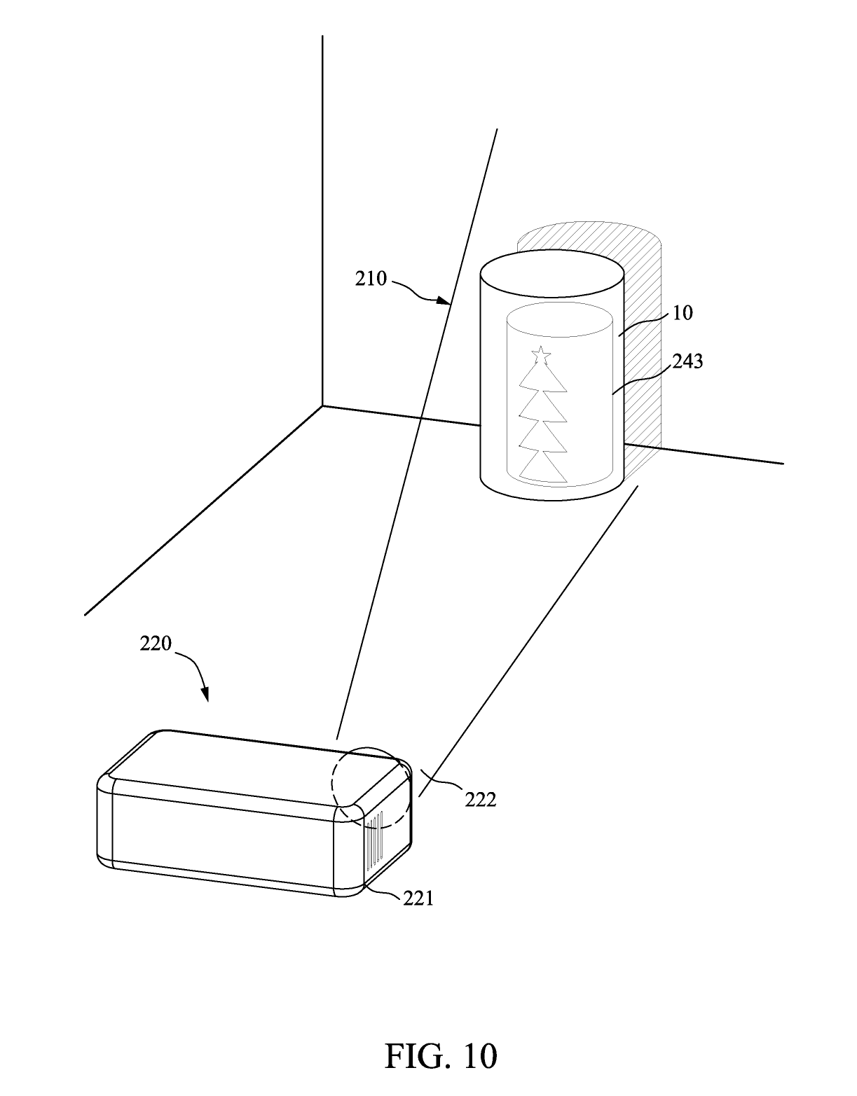

Please refer to FIGS. 7 and 10. In the mapping step 22, a projection unit 221 of a projection device 220 is used to project and map the image 210 containing the projection model 243 onto the target object 10 in a direction matching the angle of view 222. Again, the contour of the projection model 243 contained in the image 210 projected onto the target object 10 by the projection unit 221 might be different from the actual contour of the target object 10 due to some factors, such as the projection device, the site or other factors. Therefore, the method goes to the adjusting step 23.

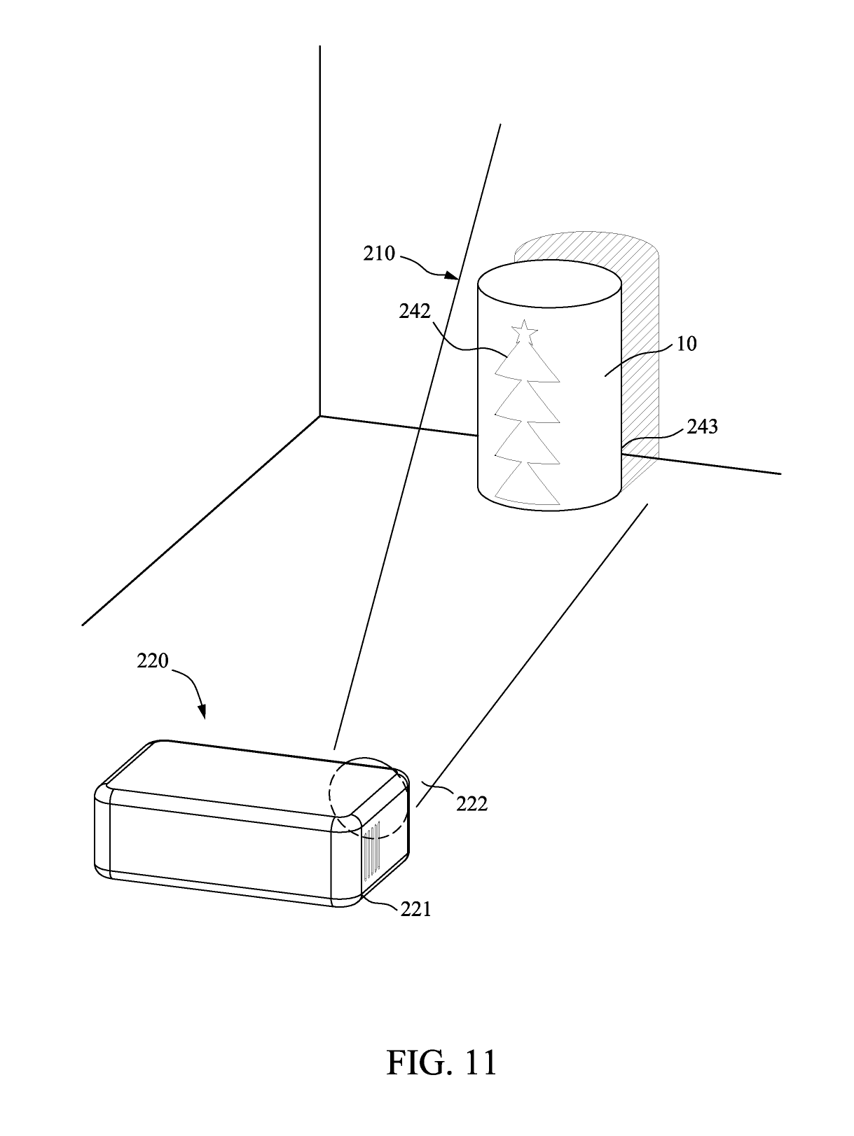

As shown in FIG. 11, in the adjusting step 23, the projection model 243 that is seen on the screen of the computer and captured to be put on the surface of the image 210 can be rotated, shifted and/or re-sized until the projection model 243 contained in the image 210 and projected from the projection unit 221 has a contour completely matching the contour of the target object 10. For any detail about the ways to perform the above adjustment of the projection model 243 and to determine whether the contour of the adjusted projection model 243 has already matched the contour of the target object 10, please refer to the corresponding descriptions of the first embodiment.

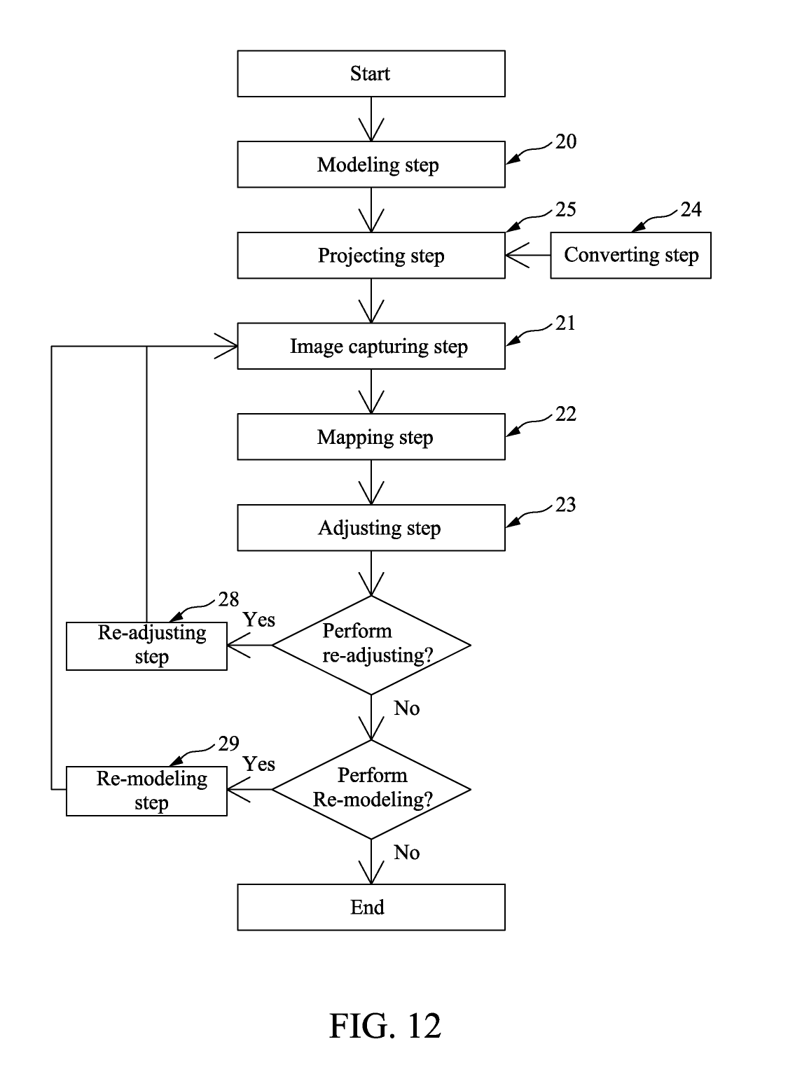

Please refer to FIG. 12, which is a flowchart showing the steps included in a third embodiment of the method according to the present invention. In considering that more situations might occur when implementing the method of projection mapping of the present invention, the third embodiment of the method is established on the basis of the second embodiment and further includes a re-adjusting step 28 and a re-modeling step 29. More specifically, in the event the image 210 has been finalized after the adjusting step 23 but there is still any change in the orientation, the angle and/or the position of the projection device 220 relative to the target object 10 or any deviation between the shape of the target object 10 and the 3D model 202, the projection model 243 can still be re-adjusted, so that the projection model 243 contained in the image 210 projected from the projection device 220 can match the contour of the target object 10 again. Similarly, in implementing the third embodiment of the present invention, there is not any particular limit to the ways for determining any of the above-mentioned situations and to the adjustment of the projection model 243. For any detail about the ways to perform the above re-adjustment of the projection model 243 and to determine whether the contour of the adjusted projection model 243 has already matched the contour of the target object 10, please refer to the corresponding descriptions of the first and second embodiments.

As can be seen in FIG. 12, the first seven steps in the third embodiment of the present invention are the same as those in the second embodiment shown in FIG. 7. That is, in the third embodiment, the converting step 24 and the projecting step 25 are performed before the adjusting step 23. Thereafter, the re-adjusting step 28 and the re-modeling step 29 are further performed after the adjusting step 23. However, it is understood the re-adjusting step 28 and the re-modeling step 29 are not necessarily performed only based on the method shown in FIG. 7. In stead, the re-adjusting step 28 and the re-modeling step 29 can be added to the steps in the method according to the first embodiment shown in FIG. 1. That is, the re-adjusting step 28 and the re-modeling step 29 can be otherwise performed after the re-mapping step 27.

Referring to FIG. 12. When the adjusting step 23 has been performed and it is found the position, orientation and/or viewing angle of the projection device 220 relative to the target object 10 are somewhat changed, the re-adjusting step 28 can be further performed. To perform the re-adjusting step 28, the method goes back to the image capturing step 21 to modify the projection model 243 based on the changes in the position, orientation and/or viewing angle of the projection device 220 relative to the target object 10 until the contour of the projection model 243 contained in the image 210 projected from the projection device 220 matches the changed contour of the target object 10, and then the image 210 is captured again. According to the present invention, there is not any particular limit to the way for detecting and sensing the changes in the position, orientation and/or viewing angle of the projection device 220 relative to the target object 10. Such changes can be detected by using any conventionally known device, such as position sensors mounted on or around the target object 10, or an angle detecting dial, or just by observation with eyes.

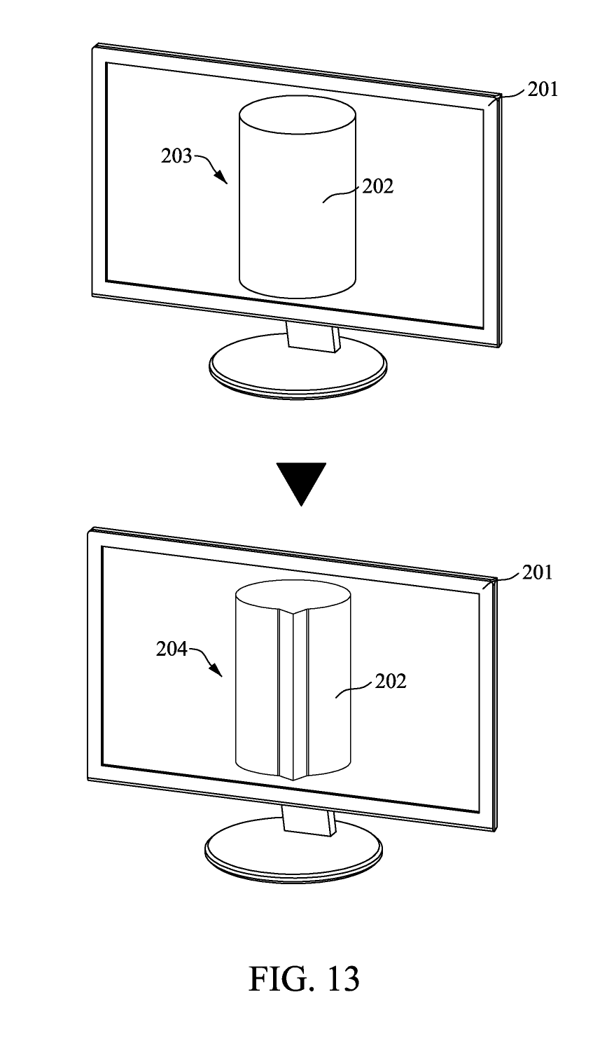

In the event the performing of the re-adjusting step 28 still fails to match the contour of the projection model 243 contained in the image 210 with the contour of the target object 10, it can be determined the non-matching is caused by some change in the contour of target object 10 that was used in the modeling step 20. That is, an original contour 203 of the target object 10 at the time the modeling step 20 was performed has changed to an after-deformation contour 204. Under this circumstance, the re-modeling step 29 must be performed. As shown in FIGS. 12 and 13, when performing the re-modeling step 29, first modify the contour of the 3D model 202 in correspondence with the difference between the after-deformation contour 204 and the original contour 203, so that the modified contour of the 3D model 202 is the same as the after-deformation contour 204 of the target object 10. Then, perform the subsequent image capturing step 21 and other steps, so that the contour of the projection model 243 contained in the final image 210 projected from the projection device 220 matches the current contour of the target object 10. Similarly, in the present invention, there is not any particular limit to the way for modifying the 3D model 202. The modification can be accomplished manually or non-manually by mounting sensors on the target object 10.

The following are some more details about the practical application of the method of the present invention. In some other embodiments similar to the previously embodiments, when performing the image capturing step 21, the background removal process 21a is further performed before the method goes to the mapping step 22, so that the contour of the projection model 243 can be more easily determined or some unnecessary portions on the image 210 can be omitted as much as possible when mapping the image 10 onto the target object 10 to thereby enhance the quality of the image 210 projected from the projection device 220, making the image 210 present only the contour and the pattern of the projection model 243 that is captured at the angle of view 222.

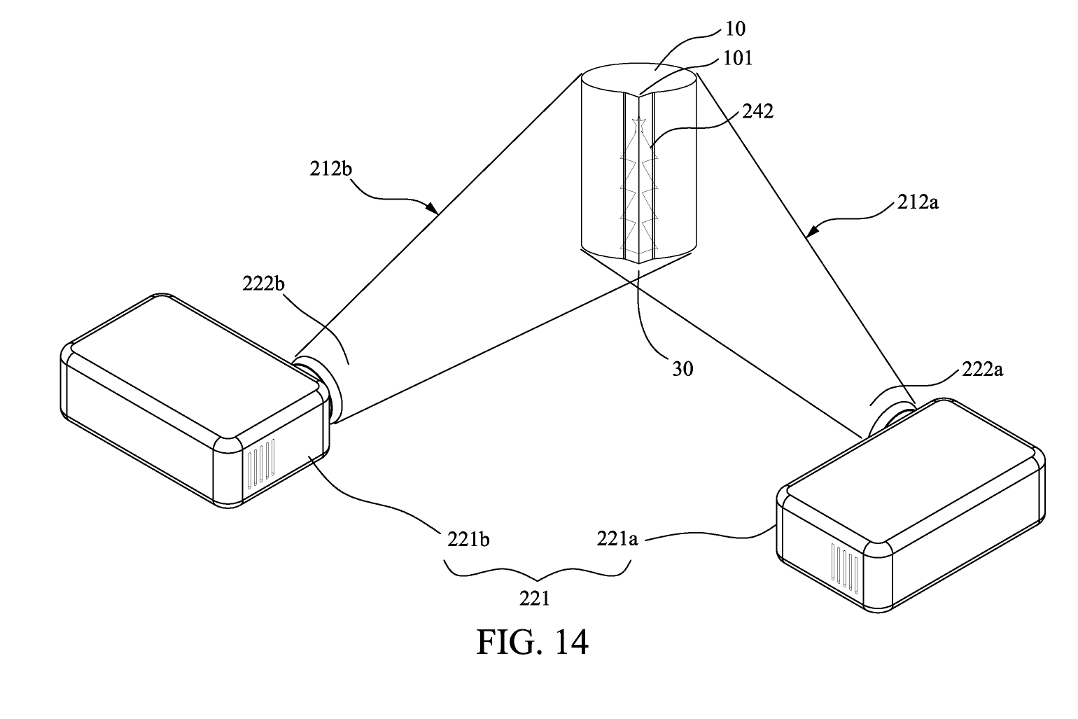

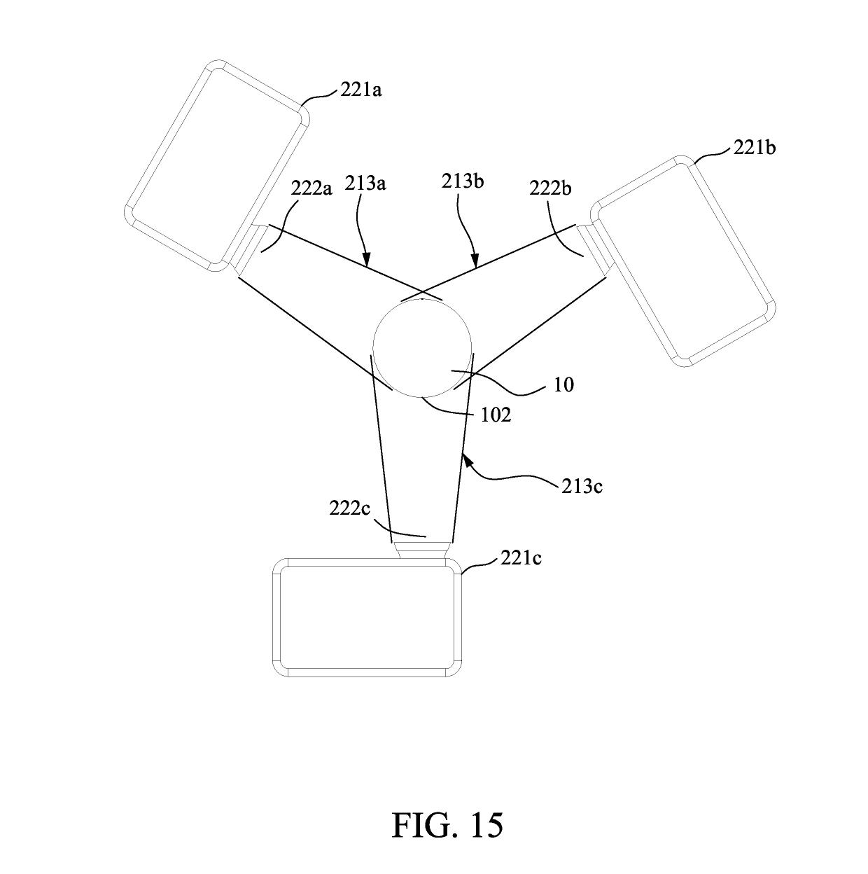

In the present invention, the projection device 220 can be used in differently ways. Please refer to FIGS. 14 and 15. In some cases, the target object 10 includes raised and recessed areas 101 on the shape thereof. These raised and recessed areas 101 produce projection dead angles and could not be covered by the image 201 projected from only one projection unit 221 at only one angle of view 222. In a fourth embodiment of the present invention, for the purpose of reducing the projection dead angles, the projection device 220 can include more than one projection unit 221, such as a first projection unit 221a and a second projection unit 221b; and in the image capturing step 21, the angle of view 222 can include a first angle of view 222a and a second angle of view 222b. The first projection unit 221a projects a first image 212a at the first angle of view 222a to map the first image 212a onto the target object 10, and the second projection unit 221b projects a second image 212b at the second angle of view 222b to map the second image 212b onto the target object 10, so that a common mapping zone 30, onto where both the first and the second image 212a, 212b are mapped, is created on the target object 10. When the first image 212a and the second image 212b are projected from different directions to cover the common mapping zone 30 and together form the video 241 to be mapped onto the target object 10, it is possible to minimize the projection dead angles that are possibly formed when the image 201 is projected from one single direction onto the target object 10 having raised and recessed areas 101 on the shape thereof.

To increase areas on the target object 10 that can present the projected video 241 for people to watch the attachment image 242 (not shown in FIG. 15) mapped onto the target object 10 from different angles, there is another way to implement the method of the present invention. Please refer to FIGS. 7 and 15. In a fifth embodiment of the present invention, more than one angle of view can be taken in the image capturing step 21. For example, a first angle of view 222a, a second angle of view 222b and a third angle of view 222c can be used to capture the image 210 to correspondingly produce a first projection image 213a, a second projection image 213b and a third projection image 213c. For this purpose, the projection device 220 may include three projection units, namely, a first projection unit 221a, a second projection unit 221b and a third projection unit 221c. As can be seen in FIG. 15, the first, second and third projection units 221a, 221b, 221c can be set surrounding the target object 10 at three different angular positions relative to the target object 10 for projecting the first, the second and the third projection image 213a, 213b, 213c at the first, the second and the third angle of view, respectively, to map the first, the second and the third projection image 213a, 213b, 213c onto the target object 10. In this case, the first, the second and the third projection images 213a, 213b, 213c together cover the entire outer surface 102 around the target object 10.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

1. A method of projection mapping for projecting and mapping an image onto a target object, comprising:
a modeling step, in which a three-dimensional (3D) model is built on or imported into an electronic device, the 3D model having a shape substantially the same as that of the target object, and being rotatable, shiftable and/or re-sizable on the electronic device;
an image capturing step, in which an image containing the 3D model is captured on the electronic device from at least one angle of view in three dimensions;
a mapping step, in which a projection device is used to project the image containing the 3D model in a direction matching the angle of view to map the image onto the target object;
an adjusting step, in which the entire 3D model shown on the electronic device is rotated, shifted and/or re-sized, to change a contour of the 3D model contained in the image until the contour of the 3D model contained in the image projected from the projection device completely matches a contour of the target object;
a converting step, in which a video is built on or imported into the electronic device and converted into an attachment image;
an attaching step, in which the attachment image is put onto a surface of the 3D model on the electronic device having been adjusted in the adjusting step, and the attachment image and the adjusted 3D model together forming a projection model, the attachment image on the projection model being rotatable, shiftable and/or re-sizable with the projection model;
a re-capturing step, in which a projection image containing the projection model is captured on the electric device in the direction matching the angle of view, after matching a shape and a range of the attachment image to a surface shape of the projected model and the angle of view;
a re-mapping step, in which the projection image containing the projection model is projected from the projection device in the direction matching the angle of view to map the projection image onto the target object; and
a re-adjusting step, in which the entire projection model is rotated, shifted and/or re-sized again when an orientation, an angle and/or a position of the projection device relative to the target object is changed, such that the contour of the projection model contained in the image projected from the projection device matches the contour of the target object again, by changing the shape or the range of the attachment image.

2. (canceled)

3. The method of projection mapping as claimed in claim 1, further comprising a re-modeling step, in which the contour of the 3D model is modified in correspondence with any difference between an original contour and an after-deformation contour of the target object, such that the modified contour of the 3D model is the same as the after-deformation contour of the target object; and then the attaching step is performed again.

4. The method of projection mapping as claimed in claim 1, wherein in the image capturing step, a background removal process is performed on the captured image, such that only the contour and a pattern of the 3D model are presented in the image captured at the angle of view.

5. The method of projection mapping as claimed in claim 1, wherein the projection device includes a first projection unit and a second projection unit, and a first angle of view and a second angle of view are used in the image capturing step; the first projection unit projecting a first image at the first angle of view to map the first image onto the target object and the second projection unit projecting a second image at the second angle of view to map the second image onto the target object, such that a common mapping zone, onto where both the first and the second image are mapped, is created on the target object.

6. The method of projection mapping as claimed in claim 1, wherein the projection device includes a first projection unit, a second projection unit and a third projection unit, and a first angle of view, a second angle of view and a third angle of view are used in the image capturing step; the first, second and third projection units being set surrounding the target object at three different angular positions relative to the target object for projecting a first, a second and a third projection image at the first, the second and the third angle of view, respectively, to map the first, the second and the third projection image onto the target object; and the first, the second and the third projection image together covering an entire outer surface around the target object.

7. A method of projection mapping for projecting and mapping an image onto a target object, comprising:
a modeling step, in which a three-dimensional (3D) model is built on or imported into an electronic device, the 3D model having a shape substantially the same as that of the target object, and being rotatable, shiftable and/or re-sizable on the electronic device;
a converting step, in which a video is built on or imported into the electronic device and converted into an attachment image;
an attaching step, in which the attachment image is put onto a surface of the 3D model on the electronic device, and the attachment image and the 3D model together forming a projection model, the attachment image on the projection model being rotatable, shiftable and/or re-sizable with the projection model;
an image capturing step, in which an image containing the projection model is captured on the electronic device from at least one angle of view in three dimensions;
a mapping step, in which a projection device is used to project the image containing the projection model in a direction matching the angle of view to map the image onto the target object;
an adjusting step, in which the entire projection model shown on the electronic device is rotated, shifted and/or re-sized, to change a contour of the projection model contained in the image until the contour of the projection model contained in the image projected from the projection device completely matches a contour of the target object, by changing a shape or a range of the attachment image; and
a re-adjusting step, in which the entire projection model is rotated, shifted and/or re-sized again when an orientation, an angle and/or a position of the projection device relative to the target object is changed, such that the contour of the projection model contained in the image projected from the projection device matches the contour of the target object again, by changing the shape or the range of the attachment image.

8. (canceled)

9. The method of projection mapping as claimed in claim 7, further comprising a re-modeling step, in which the contour of the 3D model is modified in correspondence with any difference between an original contour and an after-deformation contour of the target object, such that the modified contour of the 3D model is the same as the after-deformation contour of the target object; and then the attaching step is performed again.

10. The method of projection mapping as claimed in claim 7, wherein in the image capturing step, a background removal process is performed on the captured image, such that only the contour and a pattern of the projection model are presented in the image capture at the angle of view.

11. The method of projection mapping as claimed in claim 7, wherein the projection device includes a first projection unit and a second projection unit, and a first angle of view and a second angle of view are used in the image capturing step; the first projection unit projecting a first image at the first angle of view to map the first image onto the target object and the second projection unit projecting a second image at the second angle of view to map the second image onto the target object, such that a common mapping zone, onto where both the first and the second image are mapped, is created on the target object.

12. The method of projection mapping as claimed in claim 7, wherein the projection device includes a first projection unit, a second projection unit and a third projection unit, and a first angle of view, a second angle of view and a third angle of view are used in the image capturing step; the first, second and third projection units being set surrounding the target object at three different angular positions relative to the target object for projecting a first, a second and a third projection image at the first, the second and the third angle of view, respectively, to map the first, the second and the third projection image onto the target object; and the first, the second and the third projection image together covering an entire outer surface around the target object.
